(19) United States
(12) Patent Application Publication
(10) Pub. No.: US 2013/0195069 A1
(43) Pub. Date: Aug. 1, 2013

(54) SIGNALING MECHANISM FOR SUPPORTING FLEXIBLE PHYSICAL BROADCAST CHANNEL AND COMMON REFERENCE SIGNAL CONFIGURATIONS

(71) Applicants: Frank FREDERIKSEN, Klarup (DK); Claudio ROSA, Randers (DK); Peter SKOV, Beijing (CN); Timo Erkki LUNTTILA, Espoo (FI)

(72) Inventors: Frank FREDERIKSEN, Klarup (DK); Claudio ROSA, Randers (DK); Peter SKOV, Beijing (CN); Timo Erkki LUNTTILA, Espoo (FI)

(73) Assignee: Nokia Siemens Networks Oy, Espoo (FI)

(21) Appl. No.: 13/361,290

(22) Filed: Jan. 30, 2012

(51) Int. Cl. H04W 56/00; H04W 72/04

(52) U.S. Cl. 370/330; 370/329; 370/336

(57) ABSTRACT

A method, apparatus, system, and non-transitory computer readable medium are provided that can provide a signaling mechanism on a physical broadcast channel. The signaling mechanism generates system configuration information, and uses one or more bits within the physical broadcast channel to store system configuration information. The signaling mechanism further signals the system configuration information to devices within a cell of a communication system.

### BACKGROUND

1. Field

Some embodiments of the invention relate generally to communication systems, and particularly to Long Term Evolution (LTE)-Advanced communication systems, and other radio communication systems. Certain embodiments also generally relate to flexible configuration of a downlink channel, including a physical broadcast channel (PBCH), primary synchronization signals (PSS), and secondary synchronization signals (SSS).

2. Description of the Related Art

In LTE communication systems, a cell typically comprises an evolved node B (eNodeB) and one or more user equipments (UEs). In a cell, an eNodeB generally transmits information to the one or more UEs within a communication link, identified as a downlink (DL). Such information is generated over one or more physical downlink channels, where one of the physical channels is a PBCH. A PBCH is a physical downlink channel generally used to transmit basic system information within the cell. An eNodeB further generally transmits reference signals to the one or more UEs. Examples of such reference signals include a PSS and a SSS. A PSS and SSS are both synchronization signals that are generally transmitted by the eNodeB within the cell, and are generally used by one or more UEs to discover the cell, and to perform an initial synchronization with the eNodeB of the cell. A PBCH, PSS, and SSS can each comprise one or more physical resource elements.

In general, in LTE communication systems, the physical resource elements used for carrying a PBCH, PSS, and SSS is fixed. LTE frequency division duplexing (FDD) does allow for different cells to use different reference timing for a radio frame boundary, but for LTE time division duplexing (TDD), and when enhanced interference management is used, a timing of radio boundaries is fixed. This makes it extremely difficult to provide time or frequency domain interference management for a PBCH, PSS and SSS.

### SUMMARY

According to an embodiment of the invention, a method includes creating system configuration information that includes at least one of an absolute position of a physical broadcast channel, a primary synchronization signal, and a secondary synchronization signal within a bandwidth, or a reference symbol structure configuration. The method further includes storing the system configuration information within one or more bits of a master information block stored within a physical broadcast channel. The method further includes signaling the master information block to one or more user equipments over the physical broadcast channel.

According to another embodiment, an apparatus includes a processor and a memory including computer program code. The memory and the computer program code are configured to, with the processor, cause the apparatus at least to create system configuration information that includes at least one of an absolute position of a physical broadcast channel, a primary synchronization signal, and a secondary synchronization signal within a bandwidth, or a reference symbol structure configuration. The memory and the computer program code are further configured to, with the processor, cause the apparatus at least to store the system configuration information within one or more bits of a master information block stored within a physical broadcast channel. The memory and the computer program code are further configured to, with the processor, cause the apparatus at least to signal the master information block to one or more user equipments over the physical broadcast channel.

According to another embodiment, a method includes receiving a master information block over a physical broadcast channel, the master information block including system configuration information that includes at least one of an absolute position of the physical broadcast channel, a primary synchronization signal, and a secondary synchronization signal within a bandwidth, or a reference symbol structure configuration. The method further includes decoding the system configuration information. The method further includes, when the system configuration information includes the absolute position of the physical broadcast channel, the primary synchronization signal, and the secondary synchronization signal, shifting a cell search and selection procedure to detect the physical broadcast channel, the primary synchronization signal, and the secondary synchronization signal based on the system configuration information. The method further includes, when the system configuration information includes the reference symbol structure configuration, reconfiguring a detection procedure of reference symbols based on the system configuration information.

According to another embodiment, an apparatus includes a processor and a memory including computer program code. The memory and the computer program code are configured to, with the processor, cause the apparatus at least to receive a master information block over a physical broadcast channel, the master information block including system configuration information that includes at least one of an absolute position of the physical broadcast channel, a primary synchronization signal, and a secondary synchronization signal within a bandwidth, or a reference symbol structure configuration. The memory and the computer program code are further configured to, with the processor, cause the apparatus at least to decode the system configuration information. The memory and the computer program code are further configured to, with the processor, cause the apparatus, when the system configuration information includes the absolute position of the physical broadcast channel, the primary synchronization signal, and the secondary synchronization signal, at least to shift a cell search and selection procedure to detect the physical broadcast channel, the primary synchronization signal, and the secondary synchronization signal based on the system configuration information. The memory and the computer program code are further configured to, with the processor, cause the apparatus, when the system configuration information includes the reference symbol structure configuration, at least to reconfiguring a detection procedure of reference symbols based on the system configuration information.

According to another embodiment, an apparatus includes means for creating system configuration information that includes at least one of an absolute position of a physical broadcast channel, a primary synchronization signal, and a secondary synchronization signal within a bandwidth, or a reference symbol structure configuration. The apparatus further includes means for storing the system configuration information within one or more bits of a master information block stored within a physical broadcast channel. The apparatus further includes means for signaling the master information block to one or more user equipments over the physical broadcast channel.

According to another embodiment, a computer-readable medium includes a computer program stored therein that, when executed by a processor, causes the processor to implement a method. The method includes creating system configuration information that includes at least one of an absolute position of a physical broadcast channel, a primary synchronization signal, and a secondary synchronization signal within a bandwidth, or a reference symbol structure configuration. The method further includes storing the system configuration information within one or more bits of a master information block stored within a physical broadcast channel. The method further includes signaling the master information block to one or more user equipments over the physical broadcast channel.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a block diagram of a system, according to an embodiment of the invention.

FIG. 2 illustrates a block diagram of an example time/frequency placement of a PBCH and associated synchronization channels, according to an embodiment of the invention.

FIG. 3 illustrates a method, according to an embodiment of the invention.

FIG. 4 illustrates another method, according to an embodiment of the invention.

FIG. 5 illustrates another method, according to an embodiment of the invention.

FIG. 6 illustrates another method, according to an embodiment of the invention.

FIG. 7 illustrates an apparatus, according to an embodiment of the invention.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and non-transitory computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “an embodiment,” “one embodiment,” “another embodiment,” “an alternative embodiment,” “an alternate embodiment,” “certain embodiments,” “some embodiments,” “other embodiments,” “different embodiments” or other similar language, throughout this specification refers to the fact that a particular feature, structure, or characteristic described in connection with the embodiment may be included in at least one embodiment of the present invention. Thus, appearances of the phrases “an embodiment,” “one embodiment,” “another embodiment,” “an alternative embodiment,” “an alternate embodiment,” “in certain embodiments,” “in some embodiments,” “in other embodiments,” “in different embodiments,” or other similar language, throughout this specification do not necessarily all refer to the same group of embodiments, and the described features, structures, or characteristics may be combined in any suitable manner in one or more embodiments.

According to an embodiment of the invention, a signaling mechanism on a PBCH is provided, which can allow for more flexibility in the way that system configuration information for a communication system is communicated, and thus, can allow for more flexibility in the way that the communication system is configured. The signaling mechanism can use one or more bits of a PBCH to indicate an offset of a position of a PBCH, and corresponding PSS and SSS, where the offset is an offset of a standard synchronization mechanism (i.e., a standard position of the PBCH, and corresponding PSS and SSS. Alternatively, the signaling mechanism can use one or more bits of a PBCH to indicate an overall configuration of reference symbols. Alternatively, the signaling mechanism can use one or more bits of a PBCH to indicate both an offset of a position of a PBCH, and corresponding PSS and SSS, and an overall configuration of reference symbols.

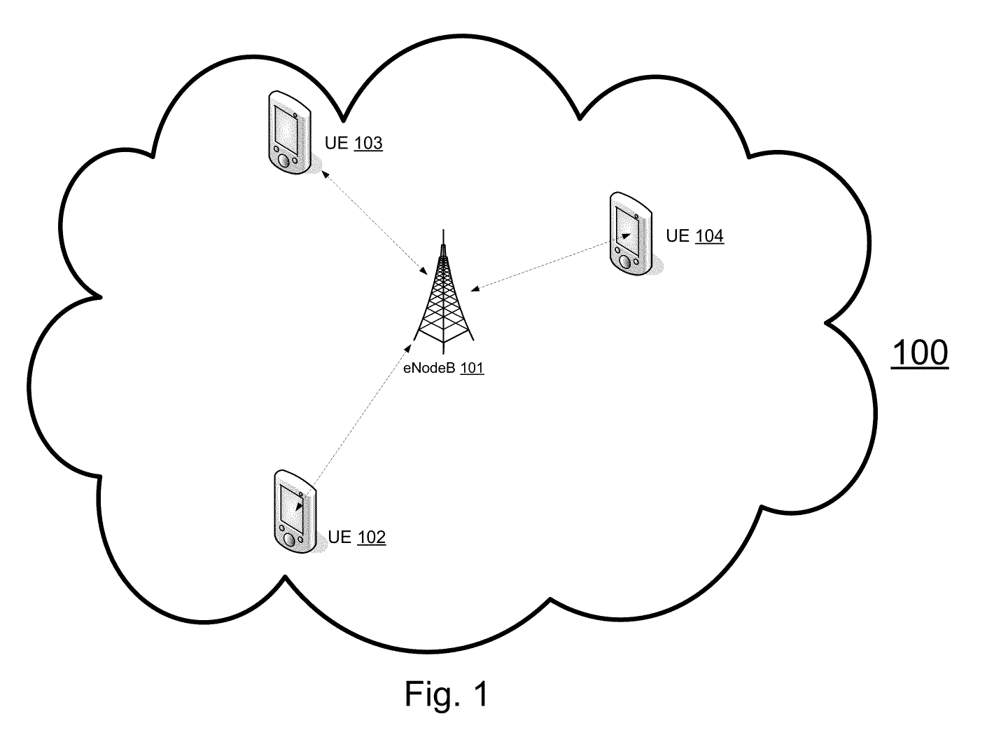

FIG. 1 illustrates a block diagram of a system 100, according to an embodiment of the invention. According to the embodiment, system 100 includes eNodeB 101. eNodeB 101 is a device operatively connected to system 100, and configured to establish a radio connection with one or more UEs using a radio interface. System 100 also include UEs 102, 103, and 104. UEs 102, 103, and 104 are each a device that is utilized by a user to communicate over system 100, such as a hand-held telephone, smartphone, laptop computer, tablet computer, or personal digital assistant (PDA). UEs 102, 103, and 104 can each establish a radio connection with eNodeB 101 using a radio interface. The radio interface facilitates a transfer of information from eNodeB 101 to the UE, and visa-versa.

According to the embodiment, the radio interface can include three layers, a physical layer, a medium access control (MAC) layer, and a radio resource control (RRC) layer. The physical layer interfaces the MAC layer and the RRC layer, and offers data transport services to higher layers. In order to provide data transport services, the physical layer provides a number of functions including frequency and time synchronization and radio characteristic measurements and indications to higher layers.

The physical layer of the radio interface further comprises a plurality of resource elements that can transport information originating from higher layers, where a radio signal comprises one or more resource grids, and each resource grid comprises one or more resource elements. The plurality of resource elements make up one or more physical channels. The physical channels can be organized into two sets of physical channels: uplink physical channels and downlink physical channels. The uplink physical channels can transport information, that originates from one of the higher layers, from a UE to eNodeB 101. The downlink physical channels can transport information, that originates from one of the higher layers, from eNodeB 101 to a UE. The physical layer of the radio interface can also produce one or more physical signals, also identified as reference signals. The reference signals can also be organized into two sets of reference signals: uplink reference signals and downlink reference signals. The reference signals can be used by the physical layer but do not carry information originating from higher layers. Further details of the physical layer of radio interface are described in 3GPP Technical Specification (TS) 36.201 version 10.0.0, 3GPP TS 36.211 version 10.4.0, and 3GPP TS 36.331 version 10.4.0, each of which are herein incorporated by reference.

According to the embodiment, one of the downlink physical channels is a PBCH. As previously described, a PBCH is a physical downlink channel used to transmit basic system information within a cell that eNodeB 101 is located. Furthermore, according to the embodiment, one of the downlink reference signals is a PSS, and another of the downlink reference signals is a SSS. Both the PSS and the PSS allow a UE to discover a cell where eNodeB 101 is located, and allow the UE to synchronize with the eNodeB, as well as allowing the UE to identify the physical cell ID of the eNodeB.

As previously described, in previous LTE communication systems, the physical resource elements used for carrying the PBCH, the PSS, and the SSS have a predetermined location in time and frequency with reference to a general system configuration of the LTE communication system. Thus, in situations where a cell that eNodeB 101 is located near an adjacent cell (not shown in FIG. 1), the adjacent cell (and its eNodeBs) can interfere with the eNodeB 101's transmission of the PBCH, the PSS, and the SSS to UEs 102, 103, and 104. According to certain embodiments of the invention, the physical resource elements used for carrying the PBCH, the PSS, and the SSS can be set on non-overlapping positions, so that the PBCH, the PSS, and the SSS transmitted by eNodeB 101 do not overlap with similar channels/signals in adjacent cells.

According to the embodiment, the system information transmitted over the PBCH can include a master information block. A master information block can include a number of essential and frequently transmitted parameters that UEs 102, 103, and 104 need to acquire other system information from eNodeB. An example of a master information block is provided below, in accordance with an embodiment of the invention:

### MasterInformationBlock

The MasterInformationBlock includes the system information transmitted on BCH.
Signaling radio bearer: N/A

### RLC-SAP: TM

Logical channel: BCCH

### Direction: E UTRAN to UE

### MasterInformationBlock

| | |
|---|---|
| -- ASN1START | |
| MasterInformationBlock ::= | SEQUENCE { |

| | |
|---|---|
| dl-Bandwidth | ENUMERATED {n6, n15, n25, n50, |
| n75, n100}, | |
| phich-Config | PHICH-Config, |
| systemFrameNumber | BIT STRING (SIZE (8)), |
| spare | BIT STRING (SIZE (10)) |
| } | |
| -- ASN1STOP | |

### MasterInformationBlock Field Descriptions

dl-Bandwidth: Parameter: transmission bandwidth configuration, NRB in downlink, see TS 36.101[42, table 5.6-1]. n6 corresponds to 6 resource blocks, n15 to 15 resource blocks and so on.
systemFrameNumber: Defines the 8 most significant bits of the SFN. As indicated in TS 36.211[21, 6.6.1], the 2 least significant bits of the SFN are acquired implicitly in the P-BCH decoding, i.e. timing of 40 ms P-BCH TTI indicates 2 least significant bits (within 40 ms P-BCH TTI, the first radio frame: 00, the second radio frame: 01, the third radio frame: 10, the last radio frame: 11). One value applies for all serving cells (the associated functionality is common i.e. not performed independently for each cell).

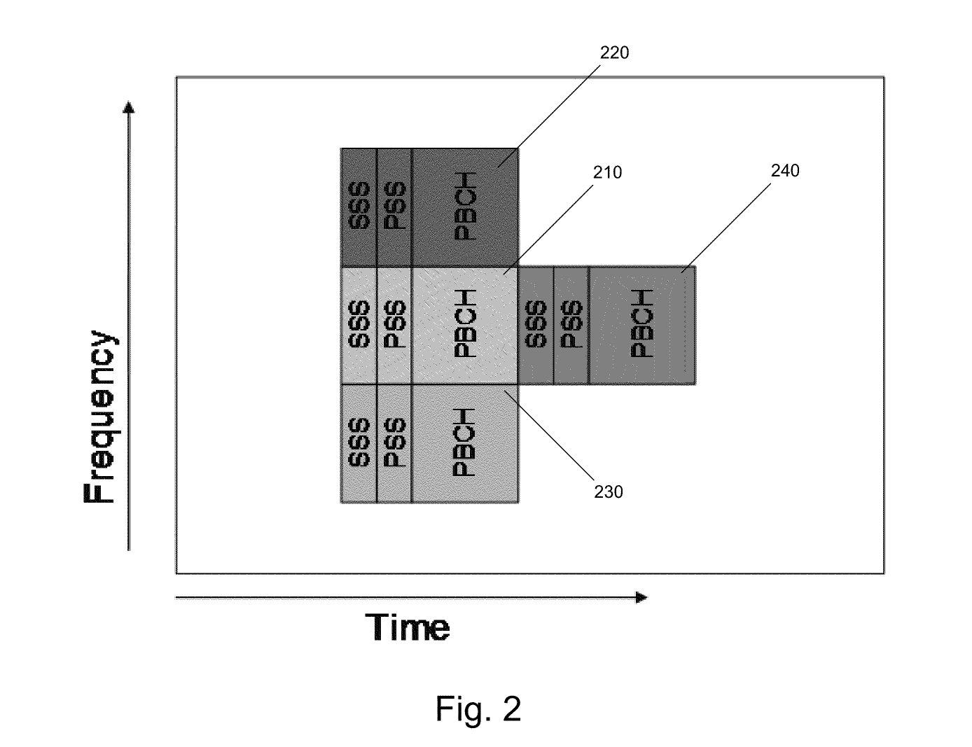

As can be seen above, the master information block includes ten bits entitled “spare.” In certain embodiments of the invention, one or more of the spare bits in the master information block are used to store information regarding an absolute position of a PBCH within a bandwidth, such as a total system bandwidth. Such information can be stored and signaled using the spare bits. The absolute position can be an offset relative to a standard position of a PBCH, such as a position of a PBCH transmitted at a center of a bandwidth. For example, two spare bits of the master information block can be reversed for indicating an offset with respect to a position of a PBCH. In some embodiments, the offset can be in a time domain (i.e., the PBCH is transmitted at a different time offset than a standard PBCH). In other embodiments, the offset can be in a frequency domain (i.e., the PBCH is transmitted at a different set of frequencies than a standard PBCH). In other embodiments, the offset can both a time domain and a frequency domain. In certain embodiments, the one or more spare bits of the master information block can also be used to store information on an absolute position of a PSS and an SSS in a similar manner as the PBCH, where an absolute position of both the PSS and the SSS are each an offset of the absolute position of the PBCH. An example of such offset position information that can be stored in the spare bits, is described in relation to FIG. 2.

In certain other embodiments of the invention, one or more of the spare bits in the master information block are used to store information regarding a configuration of a reference symbol structure. As understood by one of ordinary skill in the relevant art, eNodeB 101 can transmit one or more reference signals to UEs 102, 103, and 104, where a reference signal is generated as a product of an orthogonal sequence and a pseudo-random numerical sequence, and where a specific reference signal is assigned to each cell within a communication system and acts as a cell-specific identifier. Each reference signal, transmitted by eNodeB 101, can be based on a reference symbol structure, and can include one or more common reference symbols. Thus, the information regarding a configuration of a reference symbol structure can be used by UEs 102, 103, and 104 to properly decode a PBCH transmitted by eNodeB 101.

In some embodiments, the information regarding a configuration of a reference symbol structure can include information regarding a normal common reference symbol (CRS) configuration. In some other embodiments, the information regarding a configuration of a reference symbol structure can include information regarding a reduced CRS configuration. In yet some other embodiments, the information regarding a configuration of a reference symbol structure can include a dedicated RS configuration. These reference symbol configurations are only example embodiments, and the information regarding a configuration of a reference symbol structure could include other structures in other alternate embodiments. Thus, according to these embodiments, the master information block of the PBCH would carry information on an actual configuration of a reference symbol structure such that subsequent reception of data information would be known to UEs 102, 103, and 104 (or any UE that connects to eNodeB 101). In one embodiment, the CRS structure can be within a PBCH transmission area to ensure that the PBCH is decoded properly (coherent demodulation assumed).

In certain other embodiments of the invention, one or more additional bits of the spare bits in the master information block are used to store information regarding the system bandwidth accessible for the terminals capable of decoding and interpreting the corresponding bits. In other words, the one or more spare bits in the master information block can not only store a position of a PBCH, PSS, and SSS (either in a time domain, a frequency domain, or both), but can also store a system bandwidth. This way, it is be possible to guarantee access to backward compatible (BC) UEs, as well as UEs configured to receive the additional system configuration information previously described. Therefore, in these embodiments, eNodeB 101 can signal two system bandwidths over the PBCH: a legacy system bandwidth that is only visible to BC UEs; and a new system bandwidth that is also visible to UEs configured to receive the additional system configuration information previously described. In this way eNodeB 101 can still provide access to BC UEs in a specific region of the cell.

According to the embodiment, eNodeB 101 can store the configuration information described above (i.e., either the position offset information, the reference symbol structure configuration information, or a combination of the two) within one or more spare bits of the master information block, and transmit the master information block to UEs 102, 103, and 104, by transmitting a PBCH that contains the master information block. Thus, eNodeB 101 can provide the configuration information to UEs 102, 103, and 104, which can assist in the UEs 102, 103, and 104 properly detecting the PBCH, PSS, and SSS transmitted by eNodeB 101.

According to the embodiment, a UE (such as UEs 102, 103, and 104) can utilize a cell search procedure to identify a cell that eNodeB 101 is located in using largely the same principles as previous cell search procedures. More specifically, as understood by one of ordinary skill in the art, when a UE (such as UEs 102, 103, and 104) searches for a cell, the UE first searches for a PSS which is transmitted by an eNodeB (such as eNodeB 101). Once the UE successfully detects the PSS, the UE identifies the cell's physical layer identity. The UE then searches for a SSS which is also transmitted by the eNodeB. Once the UE successfully detects the SSS, the UE can identify a physical layer cell identity group, and can synchronize its reference timing with the eNodeB, in order to transmit and receive signals to and from the eNodeB. Subsequently, the UE receives a PBCH from the eNodeB, which the UE decodes. Once the UE has decoded the PBCH, the UE can read the information stored in the master information block, in order to receive system information about the cell. Thus, according to the embodiment, the UE can read the configuration information that is stored in the one or more spare bits of the master information block.

In certain embodiments, where the one or more spare bits in the master information block are used to store information regarding an absolute position of a PBCH, where the position information indicates an offset in a time domain, once the UE has decoded the PBCH, the UE can offset its reference timing based on the offset indicated in the one or more spare bits of the master information block. In other embodiments, where the one or more spare bits in the master information block are used to store information regarding an absolute position of a PBCH, where the position information indicates an offset in a frequency domain, the cell search procedure of the UE is slightly modified. According to the embodiment, the UE is given a set of predetermined center frequencies where it “camps” (i.e., uses as a center frequency for its fast fourier transform (FFT)). Then, on each center frequency, the UE searches for the PBCH, PSS, and SSS on a few different predefined sets of PRBs, where the different predefined sets of PRBs are defined by the offset in the frequency domain, stored within the one or more spare bits of the master information block.

One of ordinary skill in the art would readily appreciate that the configuration of system 100 illustrated in FIG. 1 is an example configuration, and that system 100 can be configured according to alternate configurations and still be within a scope of the invention. For example, system 100 can include any number of eNodeBs, or any number of UEs, or any combination of the two devices. furthermore, system 100 can include other types of devices not illustrated in FIG. 1, in addition any number of eNodeBs, or any number of UEs.

FIG. 2 illustrates a block diagram of an example time/frequency placement of a PBCH and associated synchronization channels (e.g., PSS and SSS), according to an embodiment of the invention. The illustrated embodiment includes channel sets 210, 220, 230 and 240, where each channel set include a PBCH, a PSS, and a SSS. According to the embodiment, channel set 210 represents a set of channels (i.e., a PBCH, a PSS, and a SSS) which have a standard position within a bandwidth. In the illustrated embodiment, the standard position is the center six PRBS of the system bandwidth.

Furthermore, according to the embodiment, channel set 220 represents a set of channels (i.e., a PBCH, a PSS, and a SSS) which have an offset position within a bandwidth. As illustrated in FIG. 2, the offset of channel set 220 is in the frequency domain, where channel set 220 is located in a frequency that is higher than a frequency of channel set 210. Similarly, channel set 230 also represents a set of channels (i.e., a PBCH, a PSS, and a SSS) which have an offset position within a bandwidth. Also similar to channel set 220, the offset of channel set 230 is in the frequency domain. However, unlike channel set 220, channel set 230 is located in a frequency that is lower than a frequency of channel set 220. Furthermore, channel set 240 represents a set of channels (i.e., a PBCH, a PSS, and a SSS) which have an offset position within a bandwidth. However, rather than offset being in the frequency domain, the offset of channel set 240 is in the time domain, where channel set 240 occurs at time that is later than when channel set 210 occurs. While not illustrated in FIG. 2, the offset of a channel set can be both in a frequency domain and a time domain.

Thus, according to the embodiment, information stored within one or more bits of a master information block of a PBCH can indicate an offset with respect to frequency as well as time. By signaling such information to one or more UEs, an eNodeB can indicate an absolute position of a set of channels (i.e., a PBCH, a PSS, and a SSS) which have an offset position within a bandwidth. In a further embodiment, an interpretation of the offset can depend on other system related parameters that are already known to the UE, such as physical cell identity, system bandwidth, or number of transit antennas.

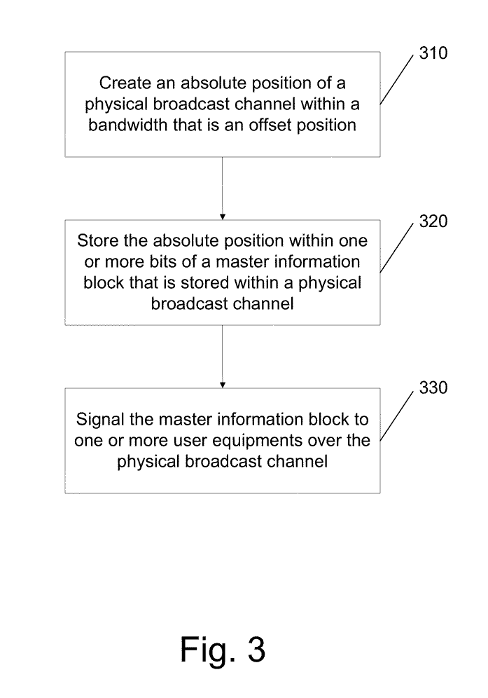

FIG. 3 illustrates a method according to an embodiment of the invention. The steps of a method or algorithm described in connection with the embodiments disclosed herein may be embodied directly in hardware, in a computer program executed by a processor, or in a combination of the two. A computer program may be embodied on a computer-readable medium, such as a storage medium. For example, a computer program may reside in RAM, flash memory, ROM, EPROM, EEPROM, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components. Furthermore, a computer-readable medium may be any type of tangible medium.

At step 310, an absolute position of a physical broadcast channel within a bandwidth is created, where the absolute position of the physical broadcast channel is an example of system configuration information, and where the absolute position of the physical broadcast channel is an offset from an absolute position of a standard physical broadcast channel. At step 320, the absolute position of the physical broadcast channel is stored within one or more bits of a master information block stored within a physical broadcast channel. At step 330, the master information block is signaled to one or more user equipments over the physical broadcast channel. In certain embodiments, steps 310, 320, and 330 are performed at an eNodeB (such as eNodeB 101 of FIG. 1).

According to certain embodiments, the standard physical broadcast channel is a physical broadcast channel that is at a center of the bandwidth. In some embodiments, the absolute position of the physical broadcast channel is offset from the absolute position of the standard physical broadcast channel in a time domain. In other embodiments, the absolute position of the physical broadcast channel is offset from the absolute position of the standard physical broadcast channel in a frequency domain. In yet other embodiments, the absolute position of the physical broadcast channel is offset from the absolute position of the standard physical broadcast channel in both a time domain and a frequency domain.

In certain embodiments, an absolute position of a primary synchronization signal is also created, where the absolute position of the primary synchronization signal is also an example of system configuration information, and where the absolute position of the primary synchronization signal is an offset from an absolute position of a standard primary synchronization signal. The absolute position of the primary synchronization signal can also be stored within one or more bits of the master information block of the physical broadcast channel.

In some of these embodiments, an absolute position of a secondary synchronization signal is also created, where the absolute position of the secondary synchronization signal is also an example of system configuration information, and where the absolute position of the secondary synchronization signal is an offset from an absolute position of a standard secondary synchronization signal. The absolute position of the secondary synchronization signal can also be stored within one or more bits of the master information block of the physical broadcast channel. In certain alternate embodiments, information regarding a system bandwidth is also created, and stored within one or more additional bits of the master information block stored within the physical broadcast channel.

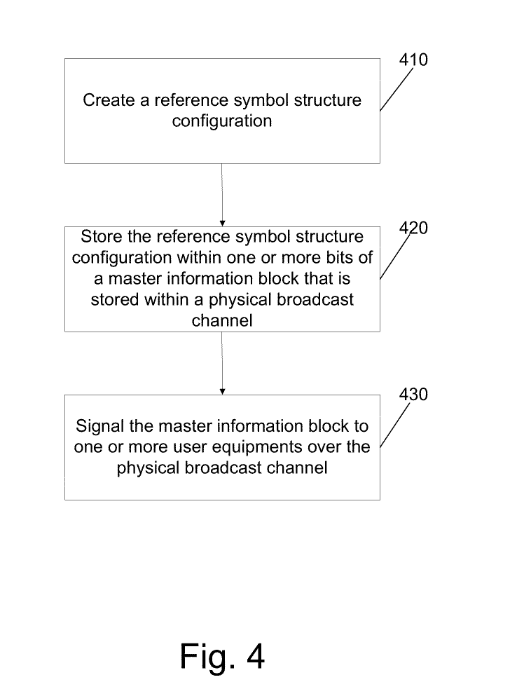

FIG. 4 illustrates a method according to an embodiment of the invention. At step 410, a reference symbol structure configuration is created, where the reference symbol structure configuration is an example of system configuration information. At step 420, the reference symbol structure configuration is stored within one or more bits of a master information block stored within a physical broadcast channel. At step 430, the master information block is signaled to one or more user equipments over the physical broadcast channel. In certain embodiments, steps 410, 420, and 430 are performed at an eNodeB (such as eNodeB 101 of FIG. 1).

In certain embodiments, the reference symbol structure configuration includes a normal common reference signal configuration. In other embodiments, the reference symbol structure configuration includes a reduced common reference signal configuration. In yet other embodiments, the reference symbol structure configuration includes a UE specific reference signal configuration.

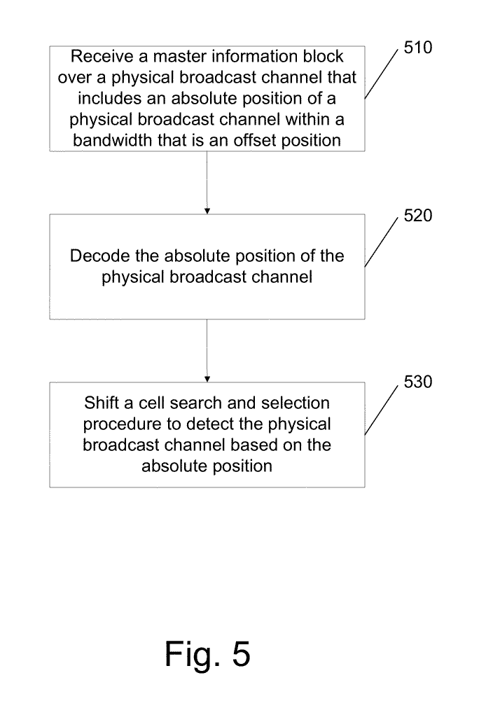

FIG. 5 illustrates another method, according to an embodiment of the invention. At step 510, a master information block is received over a physical broadcast channel. The master information block includes an absolute position of a physical broadcast channel within a bandwidth, where the absolute position of the physical broadcast channel is an example of system configuration information, and where the absolute position of the physical broadcast channel is an offset from an absolute position of a standard physical broadcast channel. At step 520, the absolute position of the physical broadcast channel is decoded. At step 530, a cell search and selection procedure to detect the physical broadcast channel is shifted based on the absolute position of the physical broadcast channel. In certain embodiments, steps 510, 520, and 530 are performed at a UE (such as UEs 102, 103, and 104 of FIG. 1).

According to certain embodiments, the standard physical broadcast channel is a physical broadcast channel that is at a center of the bandwidth. In some embodiments, the absolute position of the physical broadcast channel is offset from the absolute position of the standard physical broadcast channel in a time domain. In other embodiments, the absolute position of the physical broadcast channel is offset from the absolute position of the standard physical broadcast channel in a frequency domain. In yet other embodiments, the absolute position of the physical broadcast channel is offset from the absolute position of the standard physical broadcast channel in both a time domain and a frequency domain.

In certain embodiments, the master information block also includes an absolute position of a primary synchronization signal, where the absolute position of the primary synchronization signal is also an example of system configuration information, and where the absolute position of the primary synchronization signal is an offset from an absolute position of a standard primary synchronization signal. The absolute position of the primary synchronization signal can also be decoded, and a cell search and selection procedure to detect the primary synchronization signal can be shifted based on the absolute position of the primary synchronization signal.

In certain embodiments, the master information block also includes an absolute position of a secondary synchronization signal, where the absolute position of the secondary synchronization signal is also an example of system configuration information, and where the absolute position of the secondary synchronization signal is an offset from an absolute position of a standard secondary synchronization signal. The absolute position of the secondary synchronization signal can also be decoded, and a cell search and selection procedure to detect the secondary synchronization signal can be shifted based on the absolute position of the secondary synchronization signal.

In certain embodiments, the shifting the cell search and selection procedure further includes shifting reference timing based on the offset. In other embodiments, the shifting the cell search and selection procedure further includes searching for the physical broadcast channel, the primary synchronization signal, and the secondary synchronization signal at a frequency based on the offset.

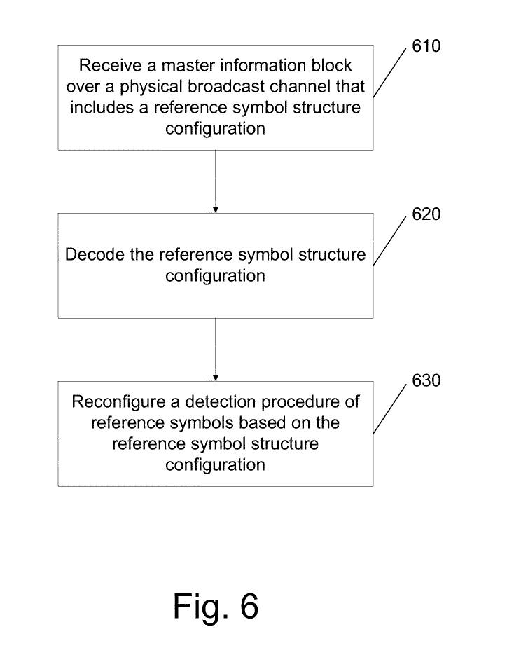

FIG. 6 illustrates another method, according to an embodiment of the invention. At step 610, a master information block is received over a physical broadcast channel. The master information block includes a reference symbol structure configuration, where the reference symbol structure configuration is an example of system configuration information. At step 620, the reference symbol structure configuration is decoded. At step 630, a detection procedure of reference symbols is reconfigured based on the reference symbol structure configuration. In certain embodiments, steps 610, 620, and 630 are performed at a UE (such as UEs 102, 103, and 104 of FIG. 1).

In certain embodiments, the reference symbol structure configuration includes a normal common reference signal configuration. In other embodiments, the reference symbol structure configuration includes a reduced common reference signal configuration. In yet other embodiments, the reference symbol structure configuration includes a UE specific reference signal configuration.

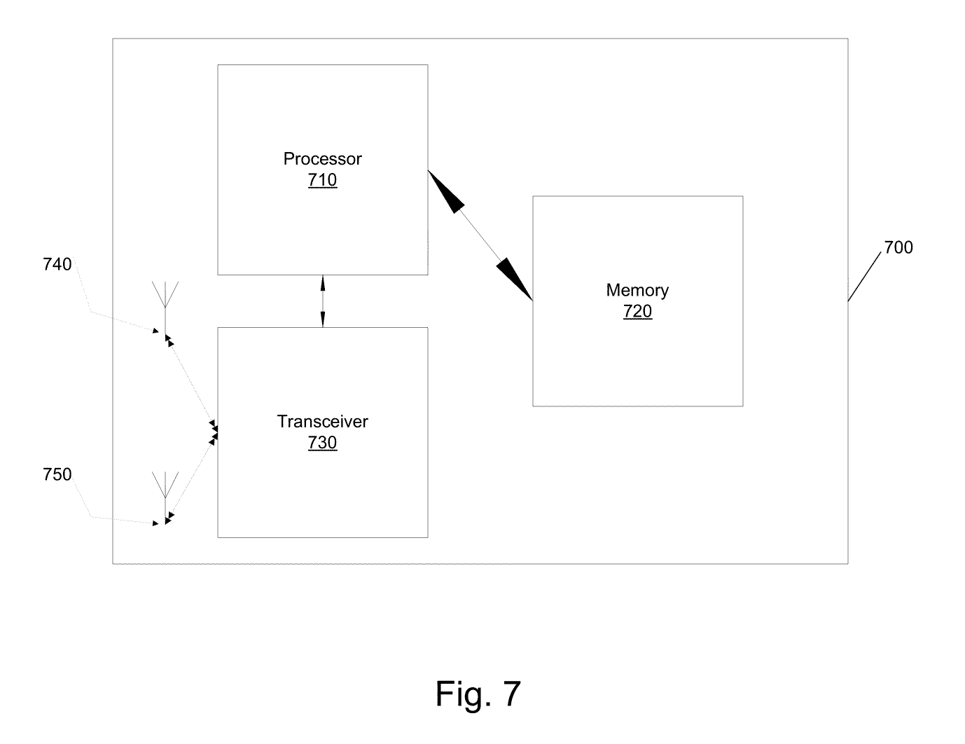

FIG. 7 illustrates an apparatus according to an embodiment of the invention. Apparatus 700 can include a processor 710 and a memory 720. Processor 710 is connected to memory 720, and can read information from, and write information to, memory 720. Processor 710 can be a front end processor, a back end processor, a microprocessor, a digital signal processor, a processor with an accompanying digital signal processor, a special-purpose computer chip, a field-programmable gate array (FPGA), a controller, an ASIC, or a computer. Memory 720 can be RAM, flash memory, ROM, EPROM, EEPROM, registers, hard disk, a removable disk, a CD-ROM, or any other form of storage medium known in the art. Memory 720 can include computer program code. As one of ordinary skill in the art would readily appreciate, apparatus 700 can include any number of processors in alternative embodiments. Likewise, apparatus 700 can include any number of memories in alternative embodiments.

Apparatus 700 can also include a transceiver 730, which is configured to transmit and receive a message, and which is connected to processor 710. Apparatus 700 can also include antennas 740 and 750, where each antenna is configured to assist transceiver 730 in the transmitting and receiving of a message. While the illustrated embodiment in FIG. 7 depicts two antennas, one of ordinary skill in the art would readily appreciate that apparatus 700 can include any number of antennas in alternative embodiments. In an alternative embodiment, apparatus 700 can include a single antenna.

In certain embodiments, memory 720 and the computer program code can, with processor 710, cause apparatus 700 to create an absolute position of a physical broadcast channel within a bandwidth, where the absolute position is an offset from an absolute position of a standard physical broadcast channel. Memory 720 and the computer program code can, with processor 710, further cause apparatus 700 to store the absolute position within one or more bits of a master information block stored within a physical broadcast channel. Memory 720 and the computer program code can, with processor 710, further cause apparatus 700 to signal the master information block to one or more user equipments over the physical broadcast channel. In some of these embodiments, apparatus 700 comprises an eNodeB.

According to certain embodiments, the standard physical broadcast channel is a physical broadcast channel that is at a center of the bandwidth. In some embodiments, the absolute position of the physical broadcast channel is offset from the absolute position of the standard physical broadcast channel in a time domain. In other embodiments, the absolute position of the physical broadcast channel is offset from the absolute position of the standard physical broadcast channel in a frequency domain. In yet other embodiments, the absolute position of the physical broadcast channel is offset from the absolute position of the standard physical broadcast channel in both a time domain and a frequency domain.

In certain embodiments, memory 720 and the computer program code can, with processor 710, further cause apparatus 700 to create an absolute position of a primary synchronization signal, where the absolute position of the primary synchronization signal is also is an example of system configuration information, and where the absolute position of the primary synchronization signal is an offset from an absolute position of a standard primary synchronization signal. Memory 720 and the computer program code can, with processor 710, further cause apparatus 700 to store the absolute position of the primary synchronization signal can also be stored within one or more bits of the master information block of the physical broadcast channel.

In some of these embodiments, memory 720 and the computer program code can, with processor 710, further cause apparatus 700 to also create an absolute position of a secondary synchronization signal, where the absolute position of the secondary synchronization signal is also an example of system configuration information, and where the absolute position of the secondary synchronization signal is an offset from an absolute position of a standard secondary synchronization signal. Memory 720 and the computer program code can, with processor 710, further cause apparatus 700 to store the absolute position of the secondary synchronization signal within one or more bits of the master information block of the physical broadcast channel. In certain alternate embodiments, memory 720 and the computer program code can, with processor 710, further cause apparatus 700 to create information regarding a system bandwidth, and store the information regarding the system bandwidth within one or more additional bits of the master information block stored within the physical broadcast channel.

In other certain embodiments, memory 720 and the computer program code can, with processor 710, cause apparatus 700 to create a reference symbol structure configuration. Memory 720 and the computer program code can, with processor 710, further cause apparatus 700 to store the reference symbol structure configuration within one or more bits of a master information block stored within a physical broadcast channel. Memory 720 and the computer program code can, with processor 710, further cause apparatus 700 to signal the master information block to one or more user equipments over the physical broadcast channel. In some of these embodiments, apparatus 700 comprises an eNodeB.

In certain embodiments, the reference symbol structure configuration includes a normal common reference signal configuration. In other embodiments, the reference symbol structure configuration includes a reduced common reference signal configuration. In yet other embodiments, the reference symbol structure configuration includes a UE specific reference signal configuration.

In other certain embodiments, memory 720 and the computer program code can, with processor 710, cause apparatus 700 to receive a master information block over a physical broadcast channel. The master information block includes an absolute position of a physical broadcast channel within a bandwidth, where the absolute position of the physical broadcast channel is an example of system configuration information, and where the absolute position of the physical broadcast channel is an offset from an absolute position of a standard physical broadcast channel. Memory 720 and the computer program code can, with processor 710, further cause apparatus 700 to decode the absolute position of the physical broadcast channel. Memory 720 and the computer program code can, with processor 710, further cause apparatus 700 to shift a cell search and selection procedure to detect the physical broadcast channel is based on the absolute position of the physical broadcast channel. In some of these embodiments, apparatus 700 comprises a UE.

According to certain embodiments, the standard physical broadcast channel is a physical broadcast channel that is at a center of the bandwidth. In some embodiments, the absolute position of the physical broadcast channel is offset from the absolute position of the standard physical broadcast channel in a time domain. In other embodiments, the absolute position of the physical broadcast channel is offset from the absolute position of the standard physical broadcast channel in a frequency domain. In yet other embodiments, the absolute position of the physical broadcast channel is offset from the absolute position of the standard physical broadcast channel in both a time domain and a frequency domain.

In certain embodiments, the master information block also includes an absolute position of a primary synchronization signal, where the absolute position of the primary synchronization signal is also an example of system configuration information, and where the absolute position of the primary synchronization signal is an offset from an absolute position of a standard primary synchronization signal. Memory 720 and the computer program code can, with processor 710, further cause apparatus 700 to decode the absolute position of the primary synchronization signal, and shift a cell search and selection procedure to detect the primary synchronization signal based on the absolute position of the primary synchronization signal.

In certain embodiments, the master information block also includes an absolute position of a secondary synchronization signal, where the absolute position of the secondary synchronization signal is also an example of system configuration information, and where the absolute position of the secondary synchronization signal is an offset from an absolute position of a standard secondary synchronization signal. Memory 720 and the computer program code can, with processor 710, further cause apparatus 700 to decode the absolute position of the secondary synchronization signal, and shift a cell search and selection procedure to detect the secondary synchronization signal based on the absolute position of the secondary synchronization signal.

In certain embodiments, memory 720 and the computer program code can, with processor 710, further cause apparatus 700 to shift reference timing based on the offset. In other embodiments, memory 720 and the computer program code can, with processor 710, further cause apparatus 700 to search for the physical broadcast channel, the primary synchronization signal, and the secondary synchronization signal at a frequency based on the offset.

In other certain embodiments, memory 720 and the computer program code can, with processor 710, cause apparatus 700 to receive a master information block over a physical broadcast channel. The master information block includes a reference symbol structure configuration, where the reference symbol structure configuration is an example of system configuration information. Memory 720 and the computer program code can, with processor 710, further cause apparatus 700 to decode the reference symbol structure configuration. Memory 720 and the computer program code can, with processor 710, further cause apparatus 700 to reconfigure a detection procedure of reference symbols based on the reference symbol structure configuration. In certain embodiments, apparatus 700 comprises a UE.

In certain embodiments, the reference symbol structure configuration includes a normal common reference signal configuration. In other embodiments, the reference symbol structure configuration includes a reduced common reference signal configuration. In yet other embodiments, the reference symbol structure configuration includes a UE specific reference signal configuration.

Thus, according to certain embodiments, advanced inter-cell interference coordination for a PBCH, PSS, and/or SSS, that can each be transmitted by an eNodeB, can be provided, which can lead to increased cell capacity (i.e., more signal traffic within the cell). This can be particularly useful in situations with an increased amount of signal traffic (and thus, where inter-cell interference is more likely), such as TDD and a heterogeneous network that includes multiple types of access nodes in a communications network. As such, this enables time domain and frequency domain inter-cell interference coordination for a PBCH, PSS, and/or SSS, and a more flexible reference symbol configuration within the cell.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
creating system configuration information that comprises at least one of an absolute position of a physical broadcast channel, a primary synchronization signal, and a secondary synchronization signal within a bandwidth, or a reference symbol structure configuration;
storing the system configuration information within one or more bits of a master information block that is stored within the physical broadcast channel; and
signaling the master information block over the physical broadcast channel.

2. The method of claim 1, wherein the absolute position of the physical broadcast channel is offset from an absolute position of a standard physical broadcast channel that is at a center of the bandwidth.

3. The method of claim 2, wherein the absolute position of the physical broadcast channel is offset from the absolute position of the standard physical broadcast channel in a time domain.

4. The method of claim 2, wherein the absolute position of the physical broadcast channel is offset from the absolute position of the standard physical broadcast channel in a frequency domain.

5. The method of claim 2, wherein the absolute position of the physical broadcast channel is offset from the absolute position of the standard physical broadcast channel in both a time domain and a frequency domain.

6. The method of claim 1, wherein the reference symbol structure configuration comprises a normal common reference signal configuration.

7. The method of claim 1, wherein the reference symbol structure configuration comprises a reduced common reference signal configuration.

8. The method of claim 1, wherein the reference symbol structure configuration comprises a user equipment specific reference signal configuration.

9. The method of claim 1, wherein the absolute position of the primary synchronization signal and the secondary synchronization signal are each offset from the absolute position of the physical broadcast channel.

10. The method of claim 1, wherein the method is performed at an evolved NodeB.

11. The method of claim 1, wherein the system configuration information further comprises information regarding the bandwidth.

12. An apparatus, comprising:
a processor; and
a memory comprising computer program code,
the memory and the computer program code configured to, with the processor, cause the apparatus to
create system configuration information that comprises at least one of an absolute position of a physical broadcast channel, a primary synchronization signal, and a secondary synchronization signal within a bandwidth, or a reference symbol structure configuration;
store the system configuration information within one or more bits of a master information block that is stored within the physical broadcast channel; and
signal the master information block over the physical broadcast channel.

13. The apparatus of claim 12, wherein the absolute position of the physical broadcast channel is offset from an absolute position of a standard physical broadcast channel that is at a center of the bandwidth.

14. The apparatus of claim 13, wherein the absolute position of the physical broadcast channel is offset from the absolute position of the standard physical broadcast channel in a time domain.

15. The apparatus of claim 13, wherein the absolute position of the physical broadcast channel is offset from the absolute position of the standard physical broadcast channel in a frequency domain.

16. The apparatus of claim 12, wherein the reference symbol structure configuration comprises a normal common reference signal configuration.

17. The apparatus of claim 12, wherein the reference symbol structure configuration comprises a reduced common reference signal configuration.

18. The apparatus of claim 12, wherein the absolute position of the primary synchronization signal, and the secondary synchronization signal are each offset from the absolute position of the physical broadcast channel.

19. The apparatus of claim 12, wherein the apparatus comprises an evolved NodeB.

20. The apparatus of claim 12, wherein the system configuration information further comprises information regarding the bandwidth.

21. An apparatus, comprising:
means for creating system configuration information that comprises at least one of an absolute position of a physical broadcast channel, a primary synchronization signal, and a secondary synchronization signal within a bandwidth, or a reference symbol structure configuration;
means for storing the system configuration information within one or more bits of a master information block that is stored within a physical broadcast channel; and
means for signaling the master information block over the physical broadcast channel.

22. A non-transitory computer-readable medium, comprising a computer program embodied therein, configured to control a processor to implement a method, the method comprising:
creating system configuration information that comprises at least one of an absolute position of a physical broadcast channel, a primary synchronization signal, and a secondary synchronization signal within a bandwidth, or a reference symbol structure configuration;
storing the system configuration information within one or more bits of a master information block that is stored within a physical broadcast channel; and
signaling the master information block over the physical broadcast channel.

23. A method, comprising:
receiving a master information block over a physical broadcast channel, the master information block comprising system configuration information that comprises at least one of an absolute position of the physical broadcast channel, a primary synchronization signal, and a secondary synchronization signal within a bandwidth, or a reference symbol structure configuration;
decoding the system configuration information;
when the system configuration information comprises the absolute position of the physical broadcast channel, the primary synchronization signal, and the secondary synchronization signal, shifting a cell search and selection procedure to detect the physical broadcast channel, the primary synchronization signal, and the secondary synchronization signal based on the system configuration information; and
when the system configuration information comprises the reference symbol structure configuration, reconfiguring a detection procedure of reference symbols based on the system configuration information.

24. The method of claim 23,
wherein the absolute position of the physical broadcast channel is offset from the absolute position of a standard physical broadcast channel in a time domain, and
wherein shifting the cell search and selection procedure further comprises shifting reference timing based on the offset.

25. The method of claim 23,
wherein the absolute position of the physical broadcast channel is offset from the absolute position of a standard physical broadcast channel in a frequency domain, and
wherein shifting the cell search and selection procedure further comprises searching for the physical broadcast channel, the primary synchronization signal, and the secondary synchronization signal at a frequency based on the offset.

26. An apparatus, comprising:
a processor; and
a memory comprising computer program code,
the memory and the computer program code configured to, with the processor, cause the apparatus to
receive a master information block over a physical broadcast channel, the master information block comprising system configuration information that comprises at least one of an absolute position of the physical broadcast channel, a primary synchronization signal, and a secondary synchronization signal within a bandwidth, or a reference symbol structure configuration;
decode the system configuration information;
when the system configuration information comprises the absolute position of the physical broadcast channel, the primary synchronization signal, and the secondary synchronization signal, shift a cell search and selection procedure to detect the physical broadcast channel, the primary synchronization signal, and the secondary synchronization signal based on the system configuration information; and
when the system configuration information comprises the reference symbol structure configuration, reconfigure a detection procedure of reference symbols based on the system configuration information.

27. The apparatus of claim 26,
wherein the absolute position of the physical broadcast channel is offset from the absolute position of a standard physical broadcast channel in a time domain, and
the memory and the computer program code are further configured to, with the processor, cause the apparatus to shift reference timing based on the offset.

28. The apparatus of claim 26,
wherein the absolute position of the physical broadcast channel is offset from the absolute position of a standard physical broadcast channel in a frequency domain, and
wherein the memory and the computer program code are further configured to, with the processor, cause the apparatus to search for the physical broadcast channel, the primary synchronization signal, and the secondary synchronization signal at a frequency based on the offset.
